(19) United States
(12) Patent Application Publication
(10) Pub. No.: US 2003/0219575 A1
(43) Pub. Date: Nov. 27, 2003

(54) Transfer sheet

(76) Inventor: Jeanlynn Mets, Sleepy Hollow, NY (US)

Correspondence Address: Dara L. Onofrio, Esq,, c/o ONOFRIO LAW, 1133 Broadway, Suite 1600, New York, NY, 10010, US

(21) Appl. No.: 10/411,677

(22) Filed: Apr. 11, 2003

Related U.S. Application Data
(60) Provisional application No. 60/372,341, filed on Apr. 11, 2002.

(51) Int. Cl. B32B 3/00

(52) U.S. Cl. 428/195.1

(57) ABSTRACT

A transfer sheet comprising a support sheet; a releasable polymer layer; and a receiving layer. An image is printed on the receiving layer and transferred to a substrate by rubbing. When the image is transferred onto the substrate, the releasable polymer layer is released from the substrate and provides a protective film for the image after it is transferred.

This application claims the benefit of U.S. Provisional Application Serial No. 60/372,341 filed on Apr. 11, 2002, which is incorporated herein by reference.

### FIELD OF THE INVENTION

The present invention relates to a printable transfer sheet comprised of a support, a releasable polymer layer and receiving layer for receiving an image that can then be transferred by rubbing onto a substrate. The present invention also relates to a method of transferring the printed image to a substrate.

### BACKGROUND OF THE INVENTION

In general, image transfer sheets are known in the art. For example, U.S. Pat. No. 6,071,611 to Ohta et al. describes a transfer sheet for transferring an ink receiving layer onto a receiving material. The ink receiving layer is adhesively laminated to a peelable substrate. When the resulting adhesive receiving layer is pressed against the receiving material, the image adheres to the receiving material and the substrate is peeled off, leaving the image on the receiving material.

U.S. Pat. No. 6,103,042 to Hatada et al. is directed to an image transfer sheet similar to that of the Ohta '611 patent. According to the detailed description of the invention in the patent, an image bearing transfer layer formed on one side of a support layer of a transfer sheet, is brought into pressure contact with a receiving member under the application of heat. The heat causes the image bearing transfer layer to soften and adhere to the receiving member. After the image transfer sheet is cooled, the support layer is peeled from the transfer layer and an image is left on the receiving member.

U.S. Pat. Nos. 6,080,261 and 6,277,299 to Popat et al. are also both directed to image transfer sheets. In these patents, an adhesive layer, which contains the image, is coated with a de-tack layer. The ink transmits through the de-tack layer and onto the adhesive layer. Thereafter, the de-tack layer is either removed or inactivated, such that the tacky adhesive layer below can adhere to the substrate and transfer the image.

The present invention is an improved transfer sheet over the transfer sheets of the patents discussed above in that it does not require a “tacky” adhesive layer, the application of heat, or a de-tack layer, to transfer the desired image. The present invention is therefore significantly easier to use, less costly and more efficient.

Accordingly, it is the broad object of the present invention to provide an easy to use transfer sheet, which can be printed with personalized designs, and/or letters that are transferred onto substrates such as paper, plastic, textiles, wood, metal, ceramics, glass, leather, formica and plaster.

It is another object of the present invention to provide a method to transfer a printed image to a substrate.

### SUMMARY OF THE INVENTION

The present invention is directed to a transfer sheet. The user prints the reverse print of an image on the transfer sheet and then rubs the image onto a substrate. In this manner, the user can select and print his/her own designs or lettering which can then be transferred onto wood, plastic, glass etc.

The transfer sheet of the present invention comprises a support sheet; a releasable polymer layer; and a receiving layer. The receiving layer is comprised of a polymer coating, which is capable of receiving an image. The polymer coating comprises at least one water-based polymer that is non-tacky at 25° C. The receiving polymer layer may further comprise pigments, optical brighteners, and/or wetting agents.

According to the invention, the image is printed on the receiving layer of the transfer sheet using a variety of methods that include ink jet printing, electrophotographic copying or laser printing. It is important to note that the resulting image that appears on the transfer sheet will be the mirror image or reverse print of what was printed by the printer or copier on the receiving layer.

The transfer sheet is further comprised of a releasable polymer layer. The releasable polymer layer is comprised of an elastomer or flexible plastic with a low glass transition temperature less than 25° C. The releasable polymer layer is coated onto said support sheet and is released from the support sheet when the image is rubbed onto a substrate. Therefore, the releasable polymer layer provides a protective film for the image after it is transferred to the substrate. The releasable polymer layer is further comprised of a material selected from the group consisting of polystyrene, poly(vinylethyl ether), phthalate plasticizer, pigment and/or wax.

The transfer sheet of the present invention also comprises a support sheet. In general the support sheet is a flexible material that also provides integrity and support to the transfer sheet. Preferably, the flexible material is selected from the group consisting of plastic and paper based materials.

The present invention is also directed to a method of transferring a printed image to a substrate. The method involves providing a transfer sheet that is comprised of a support sheet; a releasable polymer layer coated on the support sheet; and a receiving layer comprised of a polymer coating which is capable of receiving an image; placing the transfer sheet on the surface of a substrate; and transferring the printed image onto the substrate surface by rubbing.

By practicing this method the releasable polymer layer is released from the support sheet and provides a protective film for the image after it is transferred to the substrate surface.

The substrate of the present invention is selected from the group consisting of paper, plastic, textiles, wood, metal, glass, ceramics, leather, formica and plaster.

In the method of the present invention the image is printed by ink jet printing, electrophotographic copying or laser printing.

Other objects, features and advantages of the present invention will be apparent when the detailed description of the preferred embodiment of the invention are considered with reference to the drawings which should be construed in an illustrative and not limiting sense as follows:

### BRIEF DESCRIPTION OF THE DRAWINGS

FIG. 1 is a schematic illustration of the transfer sheet according to the invention.

FIG. 2 is a schematic illustration of an image printed on the transfer sheet according to the invention that is being rubbed onto a paper substrate using a pencil.

FIG. 3 is a schematic illustration of the printed image after it has been transferred to the substrate according to the invention.

### DETAILED DESCRIPTION OF THE PREFERRED EMBODIMENT

The present invention is directed to a transfer sheet 1, which allows the user to print and transfer an image onto wood, glass or plastic etc.

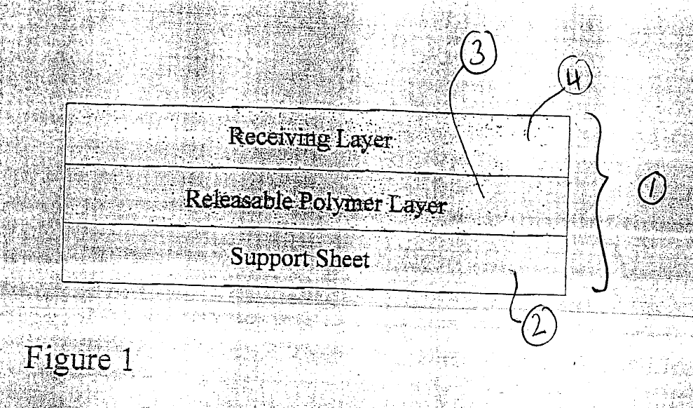

As illustrated in FIG. 1, the present invention provides a printable rub-on transfer sheet comprising: a support sheet 2; a releasable polymer layer 3; and a receiving layer 4.

In the present invention the image is printed on the receiving layer of the transfer sheet by ink jet printing, electrophotographic copying or laser printing.

A receiving layer 4 for the purpose of receiving an image is coated on the releasable polymer layer 3.

The receiving layer is comprised of a polymer coating that is capable of receiving an image. The polymer coating is comprised of a water-based polymer, which is non-tacky at 25° C., i.e. room temperature.

When the image is printed on the transfer sheet by ink jet printing the water-based polymer is preferably a binder selected from the group consisting of polyurethane, latex, polyvinyl alcohol, and carbohydrate polymers such as starch. Suitable starch polymers include but are not limited to corn. Other suitable carbohydrate polymers include cellulose and derivatives of cellulose. Most preferably, the water-based polymer is polyvinyl alcohol, starch or cellulose derivatives, or a combination of any of the above. The viscosity of the water-based polymer is greater than 100 centipoise (cP), preferably, 200-2000 cP, and most preferably, 500-1000 cP.

The amount of water based polymer in the receiving layer when the image is printed by ink jet printing is between 70-90% by weight of the coating, most preferably 80-90% by weight of the coating. After the image is printed, the ink or dye resides in the receiving layer.

In the embodiment where the image is printed by ink jet printing, the receiving layer polymer coating can further comprise pigments, optical brighteners, and/or wetting agents. The pigments are preferably selected from the group consisting of alumina sol, alumina tri-hydrate, calcined clay, calcium carbonate, gypsum, and silica. Most preferably the pigment is alumina sol or silica.

Suitable optical brighteners, also referred to by those skilled in the art as fluorescent whitening agents, are preferably derivatives of diaminostilbene disulphonic acid, such as, for example, Tinopal HST, (Ciba Specialty Chemicals, Tarrytown, N.Y.).

A suitable wetting agent, which is also referred to as a surfactant by those skilled in the art, is preferably octylphenoxypolyethoxy-ethanol, such as, for example, Triton X-100 (The Dow Chemical Co., Midland, Mich.).

The amount of pigment is preferably 10-30% by weight of the coating. The amount of wetting agent is less than 1% by weight of the coating and the amount of optical brightener is about a drop (this can be increased depending on the amount of the coating that is being made).

In the embodiment where the image is being printed by electrophotographic copying or laser, the water-based polymer is a binder that is preferably styrene butadiene latex or starch. After the image is printed, the image or toner resides in the receiving layer.

Also in the case of electrophotographic copying or laser the pigment is preferably one selected from the group consisting of alumina tri-hydrate, calcined clay, calcium carbonate, kaolin clay, titanium dioxide, and a combination of any of the above. Most preferably, the pigment is calcium carbonate.

In this embodiment, an additional plastic pigment is preferably added to the receiving layer. The amount of plastic pigment in this coating embodiment ranges from 0 to 30% and is most preferably between 5 to 10%.

When the image is printed by electrophotographic copying, or laser printing the amount of water based polymer is preferably 10-30% by weight of the coating most preferably 10-20%. The total amount of pigment (including plastic pigment) is preferably 70-90% by weight of the coating, most preferably 80-90%.

FIG. 1 further illustrates a releasable polymer layer 3 is coated on the support sheet of the transfer sheet of the present invention. The releasable polymer layer is comprised of an elastomer or flexible plastic. The elastomers or flexible plastics used in the invention have a low glass transition temperature to permit the polymer chains that comprise the releasable polymer layer to move easily within the layer. These moving polymer chains impart flexibility to the releasable polymer layer. Preferably, the glass transition temperature (T_{g}) of the materials used in the invention are less than 25° C.

A preferred suitable elastomer is poly(vinylethyl ether). In addition to elastomer or flexible plastic materials, the releasable polymer layer can further comprise other additives such as polystyrene, styrene butadiene rubber, phthalate plasticizer, pigment and/or wax.

Preferably the pigment is selected from the group consisting of alumina sol, alumina tri-hydrate, calcined clay, kaolin clay, calcium carbonate, gypsum, silica and titanium dioxide. Most preferably, the pigment is silica.

Preferably the wax is emulsified polyethylene wax.

The releasable polymer layer is coated onto said support sheet and is released from said support sheet when the image is rubbed onto a substrate. The releasable polymer layer provides a protective film for the image after it is transferred to the surface of the substrate.

The support sheet 2 illustrated in FIG. 1 is a flexible material such as plastic or paper based materials. The support should provide integrity and support but be flexible enough to have the capability of passing through a printer or copier. The plastic materials suitable for the support sheet are preferably selected from the group consisting of polystyrene, poly(ethylene terephthalate) or PET, and polyvinyl chloride. The most preferable material is polystyrene.

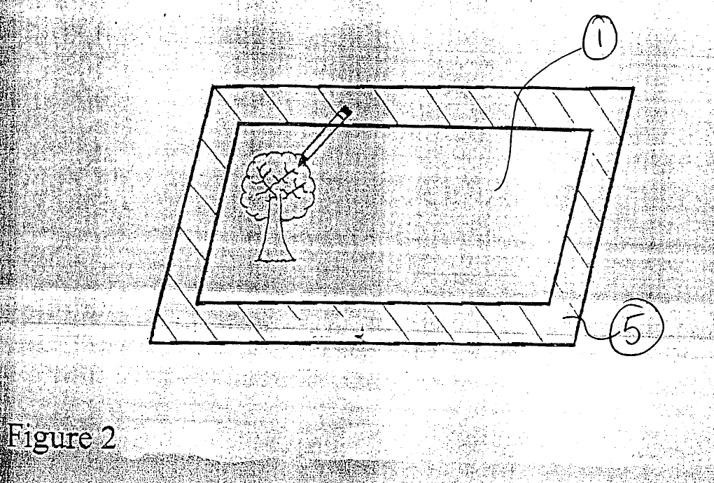

As illustrated in FIG. 2, the transfer sheet containing the desired printed image is rubbed onto a substrate 5 by placing pressure on the back of the transfer sheet 1, i.e. by rubbing the exposed side of the support sheet, with a stick, pencil, or other suitable tool. As seen in FIG. 2, the substrate is paper and the transfer sheet containing the printed image of a tree is rubbed onto the paper with a pencil. The resulting image that appears on the substrate will be the mirror image or reverse print of what was printed by the printer or copier on the receiving layer.

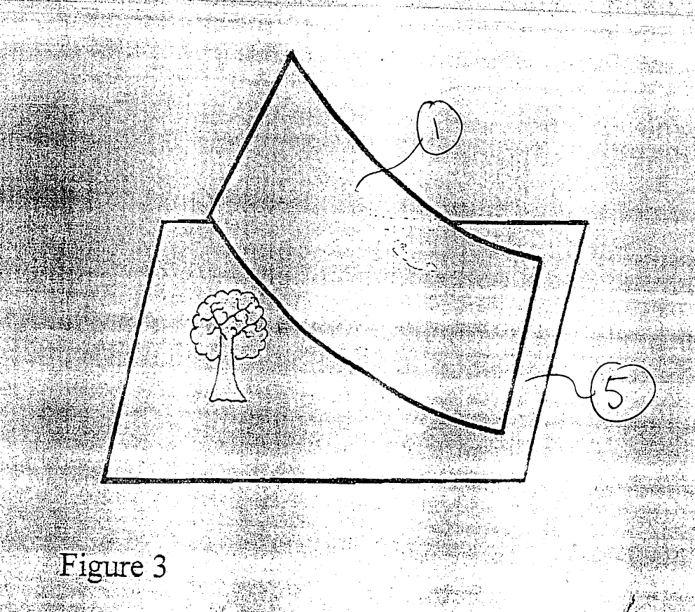

Further illustrated in FIG. 3, after the transfer sheet containing the printed image is rubbed onto the intended substrate, the transfer sheet is removed from making contact with the substrate. The transfer sheet does not stick to the substrate and thus, does not require that any of the layers be peeled away from the image. Once rubbing is complete and the transfer sheet is removed from making contact with the substrate, the printed image remains on the paper. A film will appear on the image, which is the protective film provided by the releasable polymer layer.

Preferably, substrate 5 is selected from the group consisting of paper, plastic, textiles, wood, metal, ceramics, glass, leather, formica and plaster. Most preferably, the substrate is paper.

The present invention is also directed to a method of transferring a printed image to a substrate. The method involves providing a transfer sheet that is comprised of a support sheet; a releasable polymer layer coated on the support sheet; and a receiving layer comprised of a polymer coating, which is capable of receiving an image. The transfer sheet is placed on the surface of a substrate and the printed image is transferred onto the substrate surface by rubbing. By practicing this method the releasable polymer layer is released from the support sheet and provides a protective film for the image after it is transferred to the substrate surface, thereby providing durability. As indicated earlier, preferably, the substrate is selected from the group consisting of paper, plastic, textiles, wood, metal, ceramics, glass, leather, formica and plaster.

In the method of the present invention the image is printed by ink jet printing, electrophotographic copying or laser printing.

The following Example serves to illustrate the invention but is not meant to be limiting in any sense:

### EXAMPLE 1

A water-soluble polymer that is non-tacky at 25° C. was coated onto a releasable polymer layer using a #6 Meyer rod.

This receiving layer coating comprised:

94% by weight cellulose derivative polymer;

5% by weight polyvinyl alcohol;

1% by weight TX-100; and

1 drop of Tinopal HST

More particularly, the cellulose derivative used in the receiving layer comprised 45 wt % of an alkyl derivatized cellulose with number average molecular weight (Mn) of 26,000 and 49 wt % of an alkyl derivatized cellulose with Mn of 86,000.

The releasable polymer layer used in this example is commercially available as Tulip® Premium Rub-on Transfer, Duncan Enterprises, Fresno, Calif. 93727.

The receiving layer coating was coated onto the releasable polymer layer and the coated sheet was then dried by placing it in a hot air oven, at 100° C. for a few seconds.

The resulting sheet was attached onto a paper support and a test pattern was printed using an Epson 777 printer in the transparency mode. The image was received in the ink receiving layer. The ink was allowed to dry.

The printed image of the transfer sheet was then rubbed onto a paper substrate with a wooden stick. The colored portions of the printed image transferred onto the paper. A film of ink was observed on the transferred image.

From the results of this Example it is within the scope of the invention to encompass creating a variety of images and designs in and ink receiving layer and transferring such onto various substrates.

In addition, although the Example illustrates printing by ink jet printing the similar transfer results are obtained in other embodiments using electrophotographic copying or by laser printing.

The invention now being fully described, it will be apparent to one of ordinary skill in the art that many changes and modifications can be made thereto without departing from the spirit or scope of the invention as set forth herein.

1. A transfer sheet comprising:
a support sheet;
a releasable polymer layer; and
a receiving layer comprised of a polymer coating which is capable of receiving an image;
wherein said releasable polymer layer is coated onto said support sheet and is released from said support sheet when the image is rubbed onto a substrate.

2. The transfer sheet as defined in claim 1 wherein the image is printed on said receiving layer by ink jet printing.

3. The transfer sheet as defined in claim 1 wherein the image is printed on said receiving layer by electrophotographic copying.

4. The transfer sheet as defined in claim 1 wherein the image is printed on said receiving layer by laser printing.

5. The transfer sheet as defined in claim 1, wherein said receiving layer polymer coating is comprised of at least one water-based polymer that is non-tacky at 25° C.

6. The transfer sheet as defined in claim 5 wherein said water-based polymer is selected from the group consisting of polyurethane, latex, polyvinyl alcohol, starch, cellulose and derivatives of cellulose.

7. The transfer sheet as defined in claim 6 wherein said receiving layer polymer coating further comprises pigments, optical brighteners and/or wetting agents.

8. The transfer sheet as defined in claim 7 wherein said pigments are selected from the group consisting of alumina sol, alumina tri-hydrate, calcined clay, kaolin clay, calcium carbonate, gypsum, silica and titanium dioxide.

9. The transfer sheet as defined in claim 8 further comprising plastic pigment.

10. The transfer sheet as defined in claim 1 wherein said releasable polymer layer is comprised of an elastomer or flexible plastic with a glass transition temperature less than 25° C.

11. The transfer sheet as defined in claim 10 wherein the elastomer is poly(vinylethyl ether).

12. The transfer sheet as defined in claim 11 wherein the releasable polymer layer is further comprised of a material from the group consisting of polystyrene, styrene butadiene rubber, phlathate plasticizer, pigment and wax.

13. The transfer sheet as defined in claim 12 wherein the pigment is selected from the group consisting of alumina sol, alumina tri-hydrate, calcined clay, kaolin clay, calcium carbonate, gypsum, silica and titanium dioxide.

14. The transfer sheet as defined in claim 1 wherein said substrate is selected from the group consisting of paper, plastic, textiles, wood, metal, ceramics, glass, leather, formica and plaster.

15. The transfer sheet as defined in claim 1 wherein said releasable polymer layer provides a protective film for the image after it is transferred to said substrate surface.

16. The transfer sheet as defined in claim 1, wherein said support sheet is a flexible material and is selected from the group consisting of plastic and paper based materials.

17. The transfer sheet as defined in claim 16 wherein said plastic is selected from the group consisting of polystyrene, poly(ethylene terephthlate) and polyvinyl chloride.

18. A method of transferring a printed image to a substrate comprising:
providing a transfer sheet and placing said transfer sheet on the surface of a substrate;
wherein said transfer sheet is comprised of a support sheet; a releasable polymer layer coated on said support sheet; and a receiving layer comprised of a polymer coating which is capable of receiving an image; and
transferring the printed image onto said substrate surface by rubbing such that said releasable polymer layer is released from said support sheet.

19. The method according to claim 18 wherein the image is printed by ink jet printing.

20. The method according to claim 18 herein the image is printed by electrophotographic copying.

21. The method according to claim 18 wherein the image is printed by laser printing.

22. The method according to claim 18 wherein said substrate is selected from the group consisting of paper, plastic, textiles, wood, metal, ceramics, glass, leather, formica and plaster.

23. The method according to claim 18, wherein said releasable polymer layer provides a protective film for the image after it is transferred to said substrate surface.
